(19) United States
(12) Patent Application Publication
(10) Pub. No.: US 2008/0039003 A1
(43) Pub. Date: Feb. 14, 2008

(54) Animal hauling system

(76) Inventor: Kevin M. Peitz, Pierce, NE (US)

Correspondence Address: VINCENT L. CARNEY LAW OFFICE, P.O. BOX 80836, LINCOLN, NE, 68501-0836, US

(21) Appl. No.: 11/891,385

(22) Filed: Aug. 10, 2007

Related U.S. Application Data
(60) Provisional application No. 60/837,204, filed on Aug. 11, 2006.

(51) Int. Cl. A22B 7/00

(52) U.S. Cl. 452/187

(57) ABSTRACT

To haul an animal carcass, a skeleton contacting pin of an animal carcass hitch is inserted into the muzzle of the animal carcass against the lower jaw at a skeleton contact point of an animal carcass. The opposite end of the hitch includes a handle with two side handle bars extending from a central location with an eye at the central location permitting one person to drag the carcass by gripping the handle, two persons to grip opposite handles with one gripping each handle bar to pull the carcass or more persons to pull the carcass by tying a rope to the eye or passing the rope through the eye so that a different person can grip each end of the rope with a safety harness. The rope pulls the skeleton contacting pin wherein the animal carcass is dragged with a skeleton and connecting tissue of the animal carcass being in tension.

### RELATED CASES

This application is a continuation-in-part of U.S. provisional application 60/837,204 filed Aug. 11, 2006 by inventor Kevin M. Peitz entitled Animal Hauling System. Applicant claims the benefit of the provisional application 60/837,204 filed Aug. 11, 2006.

### BACKGROUND OF THE INVENTION

This invention relates to systems for hauling animal carcasses.

It is known to drag animal carcasses such as deer carcasses by their upper bodies. Hunters who have killed an animal such as a deer in a wooded or swampy location may use these systems. In the prior art systems of this type, a harness is fastened about the neck and head or head and shoulders and the animal carcass is dragged by the harness. The prior art systems have a disadvantage of not providing as much stability to the carcass as desired when dragging the carcass. More specifically, with these systems, the animal carcass tends to flop from position to position, body parts tend to snag on obstacles and the harness tends to slip, causing further instability. Thus instability may cause injury from falling or from back strain.

### SUMMARY OF THE INVENTION

Accordingly, it is an object of the invention to provide a novel method and apparatus for hauling an animal carcass.

It is a still further object of the invention to provide a novel method and apparatus for stablely pulling an animal carcass along the ground.

It is a still further object of the invention to provide a novel method and apparatus for hauling an animal carcass along the ground using any number of persons at the same time to pull it.

It is a still further object of the invention to provide a method and apparatus for dragging an animal carcass along the ground with tensile force applied through the skeleton and connecting tissue from a point in the head of the animal.

It is a still further object of the invention to provide an easily fabricated simple one-piece animal carcass hitch.

It is a still further object of the invention to provide a simple animal carcass hitch that may be utilized to haul an animal from a remote location and also utilized to hang the animal by the head.

It is a still further object of the invention to provide an apparatus and method for dragging an animal through a skeleton contact point with a skeleton contacting pin.

In accordance with the above and further objects of the invention, an animal hitch has a skeleton contacting member, a jaw closing member and a handle. In the preferred embodiment, the skeleton contacting member is a pin that engages the lower jawbone. The jaw closing member in the preferred embodiment is one or more straps that hold the jaw closed. The handle is a plastic member with handle bars. However, the jaw closing member can be rigid or a strap attached to the handle or can be separate. The skeleton contacting member can be any member sufficiently strong in compression and fastened firmly to the high tensile strength handle to exert pressure on the skeleton of the animal in response to tensile force on the handle large enough to drag the animal. The handle can be any member flexible or stiff and can include a strong plastic member or a rope like member.

The animal carcass hitch is fastened within the muzzle of the animal with the skeleton contacting member pressing against the lower jaw of the animal and preferably the lower jaw at a skeleton contact point. The animal is hauled by the handle that protrudes from the muzzle. Preferably, a muzzle stabilizing strap holds the jaws together and a head stabilizing strap connects the animal hitch to the back of the animal's head or around the neck where the head connects to the neck or antlers or horns of a male species during hauling.

Advantageously, the animal carcass hitch may have a plurality of symmetrically-located gripping points on the handle for stability along the medial axis of the animal while hauling the animal. One or a plurality of persons may pull the handle while maintaining medial stability. For this purpose, the handle includes a centrally-located eye and symmetrically located handles so that multiple people may pull the animal hitch and the animal with the hitch elevating the head, neck and partial front shoulders and pulling the skeleton and connecting tissue in tension for stability. Preferably, the animal carcass hitch is coated with a non-slip brightly colored material which absorbs sound so that it may be carried without clinking noises that might frighten an animal. The skeleton contacting member It may be formed inexpensively of a material with sufficient tensile strength by any suitable method such as by injection molding or die cutting out of flat stock or vacuum molding or partly formed by such forming techniques with the attachment of separately formed parts such as in the case of a flexible cord.

From the above description, it can be understood that the animal carcass hitch of this invention has several advantages, such as for example: (1) the animal may be hauled along the ground in a stable position with the force being applied from the jaw through the skeleton and connecting tissues so that it is easily maneuverable with the head lifted and the limbs streamlined to the back of the body as if the animal is jumping over a fence, all of which are in tension through connecting tissue in the skeleton; (2) the animal carcass hitch is coated with a non-slip material to be easily kept clean; (3) the animal carcass hitch is free of sharp pointed edges that might penetrate the skin of a person hauling the animal carcass; (4) the animal carcass hitch of this invention is coated with a sound absorbing material and the hard portions of it are formed as a single unit to avoid clanking noises that might otherwise frighten animals; (5) the animal carcass hitch of this invention is small and compact and maybe easily packed and carried by a hunter; (6) the animal hitch of this invention is mounted so that a skeleton pressure point is connected in tension by a pin and held securely in place by easily connectable straps through hook and loop fasteners to avoid metal clanking parts and the like and will automatically adjust to any size animal; (7) the animal carcass hitch of this invention provides for symmetrical hauling by one person or by several people; and (8) the animal carcass hitch of this invention is easily adaptable to hang the animal carcass up by its snout so the animal can bleed out and also can be dragged behind an ATV by using the hanger attached to an ATV receiver hitch.

### BRIEF DESCRIPTION OF THE DRAWINGS

The above noted and other features of the invention will be better understood from the following detailed description when considered in connection with the accompanying drawings, in which:

FIG. 1 is a perspective view taken from the bottom of an animal carcass hitch in accordance with an embodiment of the invention;

FIG. 2 is a perspective view taken from the bottom of another embodiment of animal carcass hitch in accordance with an embodiment of the invention;

FIG. 3 is a perspective view taken from the bottom of another embodiment of animal carcass hitch in accordance with an embodiment of the invention;

FIG. 4 is a fragmentary perspective view taken from the bottom of a portion of another embodiment of animal carcass hitch similar to the embodiment of FIG. 3;

FIG. 5 is a fragmentary perspective view taken from the bottom of a portion of still another embodiment of animal carcass hitch similar to the embodiment of FIG. 3;

FIG. 6 is a perspective view showing one manner in which an individual may haul an animal carcass using the animal carcass hitch of FIG. 1 or 2;

FIG. 7 is a perspective view showing another manner in which one person may haul an animal carcass utilizing the animal carcass hitch of FIGS. 1 and 2;

FIG. 8 is a simplified perspective view showing another manner in which two individuals may haul an animal carcass using the animal carcass hitch of FIGS. 1 and 2;

FIG. 9 is a perspective view showing a manner in which three individuals may together haul an animal carcass utilizing the animal hitch of FIGS. 1 and 2;

FIG. 10 is a simplified perspective view showing a manner in which a vehicle may be utilized to pull an animal carcass using the animal carcass hitch of FIG. 1 or 2;

FIG. 11 is a fragmentary side perspective view of the animal carcass hitch of FIG. 1 illustrating important features of the invention;

FIG. 12 is a fragmentary side perspective view of the animal carcass hitch of FIG. 1 illustrating important features of the invention;

FIG. 13 is a perspective view taken from the end of the animal carcass hitch of FIG. 1 or 2 illustrating the invention;

FIG. 14 is a simplified side elevational view showing the manner in which the animal carcass hitch of the invention is mounted in an animal;

FIGS. 15, 16, 17 and 18 are side elevational views constitute a developed view showing a manner in which the animal carcass hitch of FIGS. 1 and 2 may be mounted in an animal carcass; and

FIGS. 19, 20 and 21 are perspective views taken respectively from the side, front and rear of a hanger that may be utilized in conjunction with the animal carcass hitch of FIGS. 1 and 2 to hang an animal.

### DETAILED DESCRIPTION

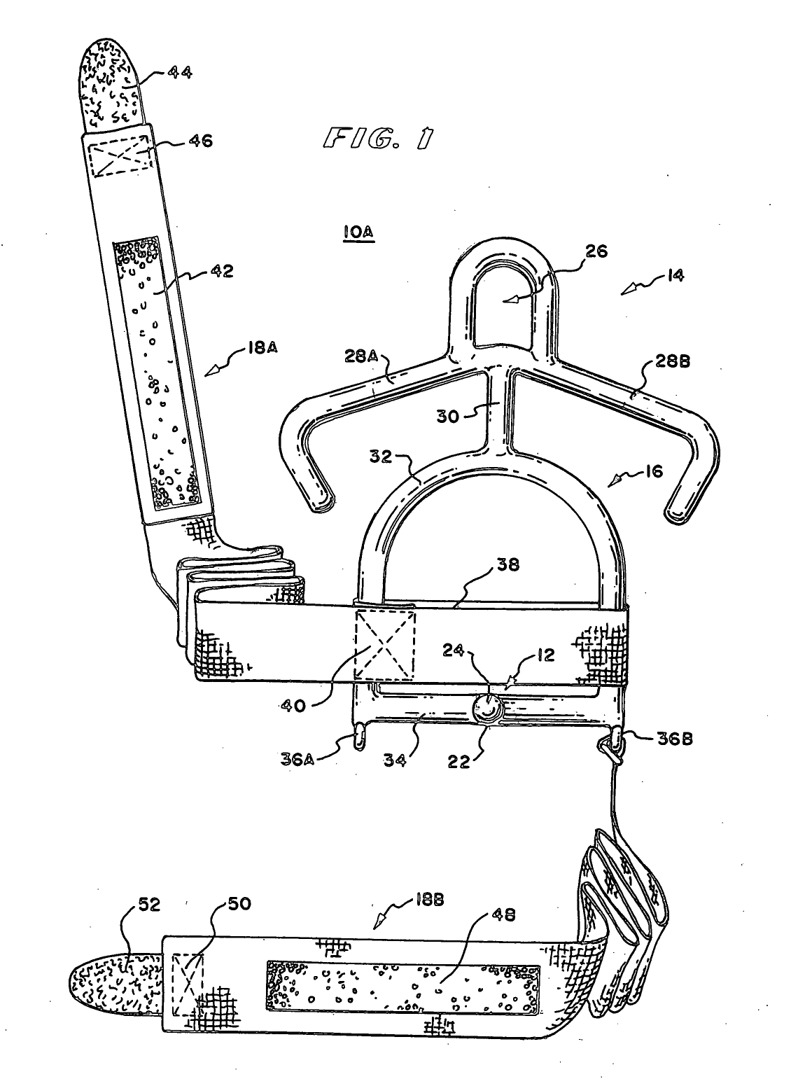

In FIG. 1, there is shown a perspective view of an animal carcass hitch 10A having a jaw pin or other skeleton contacting pin 12, a handle 14, a base 16, stabilizing straps 18A and 18B and a hanger 20 (shown in FIGS. 19-21). The handle 14 is rigidly connected to the base 16 and permits angular control of the base 16 as well as providing a support for pulling and positioning the animal carcass by a person. The skeleton contacting pin 12 is also connected and supported by the base 16. It communicates with a central skeletal supporting portion of the animal carcass. The stabilizing straps 18A and 18B are connected to the base 16 and may be wrapped around the muzzle and the head of the animal to stabilize the hitch. The skeleton contacting pin 12 is positioned along the medial axis of the animal at one end such as in the muzzle to permit stable dragging of the carcass while the base or fixture 16 and the handle 14 aid in positioning the carcass angularly.

In this specification, “skeletal supported portion” means the tissue or bone that provides a firm contact with the pin 12 and the skeletal framework of the animal sufficient to avoid slipping from movement of the skeleton itself. It may directly be a bone portion such as the lower jaw. This portion of support must pull upon the bone structure itself and the connecting tissue connecting the bones so that pulling at this point moves the skeletal framework of the animal in a symmetrical manner. The hanger 20 (FIGS. 19, 20 and 21) is shaped to engage a portion of the handle 14 and enable the animal carcass to be hung by the handle 14. Tow ropes may also be attached to it.

Preferably, the animal carcass hitch is coated with a material that easily distinguishes it as not being an animal that might be hunted. The coat preferably should be a non-slip material that will not slip out of the hunter's hands and a material that muffles sound and does not make excessive noise when hitting other objects. Generally, it is a rubberized coating and may be colored bright orange to be easily distinguishable as an inanimate object and less likely to be mistaken by hunters for a deer or other animal they are seeking. The base 16 should be made of a material sufficiently strong in tension to be able to pull the intended carcasses without excessive elongation or exceeding the yield point. It may for example be made of a hard metal. It should be able to withstand at least 300 pounds in tension. It should be sufficiently stiff so that the animal carcass can be moved angularly by twisting the handle 14.

The skeleton contacting pin 12 in the embodiment of FIG. 1 includes a cylindrical base 22 and a rounded crown 24. The cylindrical base 22 in this embodiment extends perpendicularly from the base 16 to which it is attached and is approximately one and a quarter inches high with a diameter of approximately three-eighth of an inch up to one-half of an inch. However, its diameter and length may vary depending on the animal, the weight of the animal and the size of the animal. It only need have dimensions sufficient so that the animal carcass may be pulled with the skeletal contacting pin 12 engaging a skeleton contact point on the animal carcass with the pin 12 and base 16 being pulled with sufficient force to move the animal carcass along the ground.

In this specification, the words “skeleton contact point” means a point at which the skeleton contacting pin 12 is in close enough proximity or connected to a skeletal bone through sufficiently firm tissue or directly against the bone to exert force on the skeleton sufficient so that pulling at that point creates tension along a substantial portion of the skeleton sufficient to move the entire animal with stability. Thus, the skeleton contacting pin 12 is an elongated member connected at one end to the base 16 of an animal carcass hitch from which it extends with sufficient length, width and strength to permit an animal to be dragged along the ground by the pin when the pin is pulled and the pin is at a skeleton contact point. It will generally be between one-quarter of an inch and five inches in length. In the preferred embodiment, it is one and one-quarter inches in length and is intended for deer. Its diameter must be sufficient to pull the animal carcass without breaking or bending beyond its yield point. In the preferred embodiment, it is three-eighth of an inch in diameter.

The handle 14 has several symmetrically positioned gripping points to permit pulling the animal carcass in a stable position. In this specification, the words “gripping point” mean any point at which a pulling force can be applied to the skeleton contacting pin 12 whether it is by the hand or a rope or other connection including connection to vehicles or the like. The gripping points are positioned to provide a multiple symmetrical gripping point handle. In this specification, the words “multiple symmetrical gripping point handle” means a handle for the animal carcass hitch that has a plurality of gripping points with at least one being along the central axis of the hitch, the medial axis of the animal carcass and the skeleton contacting pin 12 and at least two others being symmetrically located about the central axis such as one on each side of the center of the handle 14 and symmetrically located with respect to the skeleton contacting pin 12. In the preferred embodiment, there is one gripping point that is aligned with the central axis and the jaw pin or pins. It includes at least one eye 26. Other gripping points are right and left side handle bars 28A and 28B.

The eye 26 is bounded by integrally formed hard metal interior, plastic exterior metal connecting to the side bars 28A and 28B. The eye 26 may be used to attach a strap or for hanging the animal carcass from the hanger 20 (FIGS. 19-21). The right and left side bars 28A and 28B provide a gripping area for the hands. They are generally sized so that either two persons or one person may drag the deer holding onto the side bars. They are generally angled downwardly to prevent the hands from slipping since slipping against the force will move them upwardly towards the eye 26 rather than downwardly towards the carcass. At the ends they are bent still further inwardly with a relatively sharp bend to further prevent slipping of the hands. The handle 14 is integrally formed with the base 16.

To support the handle 14 and the skeleton contacting pin 12, the base 16 includes a handle connecting section 30, a muzzle portion 32, a pin connection portion 34 and right and left head strap loops 36A and 36B. The handle connecting portion 30 connects to the eye 26 and to the right and left side bars 28A and 28B at a location between the right and left side bars at one of its ends and at its other end, it connects to a central peripheral portion of the muzzle portion 32. The muzzle portion 32 is formed as an arc with the center of the arc being integrally formed at the end of the handle connecting section 30 and its two distal ends communicating with opposite ends of the pin connection portion 34. In the preferred embodiment, the base 16 includes integrally formed elongated members. In this configuration, the muzzle portion 32 is shaped as an arc having a curved portion and two rigid parallel sides with the ends of the parallel sides being connected to opposite sides of the pin connecting portion 34. However, it could take any shape such as a solid flat shape or openings could be provided in a central portion of a thin solid plate. The preferred embodiment is formed of bent solid metal parts that form a frame to support the pin 12, the handle 14 and the stabilizing straps 18A and 18B.

The eye 26, right and left side bars 28A and 28B, handle connecting section 30, muzzle portion 32 and pin connecting portion 34 are all made of hard material such as metal and shaped from elongated members. They may be metal tubular bars or flat members and can be formed separately and connected such as by welding or can be integrally cast. The right and left head strap loops 36A and 36B have their open portions in line with the general plane of the muzzle 32 to receive straps. The muzzle portion 32 is shaped to curve around the perimeter of the inside of the carcass muzzle when inserted and to support the straps 18A and 18B. The strap 18A is connected slideably around the two parallel sides of the muzzle portion 32 sufficiently loose to slide up or down as needed when the base 16 is inserted into the muzzle of the animal.

The stabilizing strap 18A includes a strap loop portion 38, a stitch portion 40, a loop section 42 of a hook and loop fastener, a hook portion 44 of the hook and loop fastener, and a stitched portion 46 for combining the loop portion 44 of the hook and loop fastener to the stabilizing strap 18A. The loop portion 38 fits underneath the jaw of the animal so that the lower jaw fits between the loop 38 and the pin connecting portion 34. The stabilizing strap 18A is held by the loop portion 38 which can slide up and down the muzzle portion 32 of the base 16 to accommodate different sizes of jaws. While the loop portion 38 is fabric in the preferred embodiment, any moveable member including a solid member can be used. Instead of being a loop, the member can move on any conventional bearing that permits sliding action. Thus, the connecting portion 34 and the loop portion 38 form an adjustable fixture with sides, one of which fits below the jaw and the other of which fits inside the muzzle of the animal. The sides are movable with respect to each other and the one inside the muzzle supports the skeleton contacting pin 12.

The loop portion 38 in the preferred embodiment is formed of strap material looped around the muzzle portion 32 and sewn at 40. This permits adjustment to the size of the lower jaw of the carcass being pulled. The stabilizing strap 18A is used to hold the animal's muzzle shut and keep the lower skeleton contacting pin 12 tightly in place. It wraps in front of the lower skeleton contacting pin 12 completely around the muzzle of the carcass first, then around the frame to keep the lower jaw closed. It is fastened by the hook and loop sections at 44 and 42. It is made of a material to cause minimum friction with the animal's hide and keeps the muzzle of the animal carcass centered in muzzle portion 32.

The stabilizing strap 18B is constructed in a similar manner to the stabilizing strap 18A but is longer and formed to wrap around the head or neck of the animal carcass. For this purpose, it includes a loop portion 48 sewn on the flat fabric or canvas material forming the strap, a stitched portion 50 to hold the loop portion 48 of the hook and loop fastener and a hook portion 52 of the hook and loop fastener. It is connected to pass through and be threaded around the right and left head strap loops 36A and 36B until it is disassembled for wrapping around the head of the animal carcass as will be described in greater detail in connection with FIGS. 15, 16, 17 and 18 hereinafter. It is fastened at the head strap loop 36A and threaded through the head strap loop 36B. The stabilizing straps 18A and 18B may also include a buckle or hook and loop fastener to hold the jaws closed.

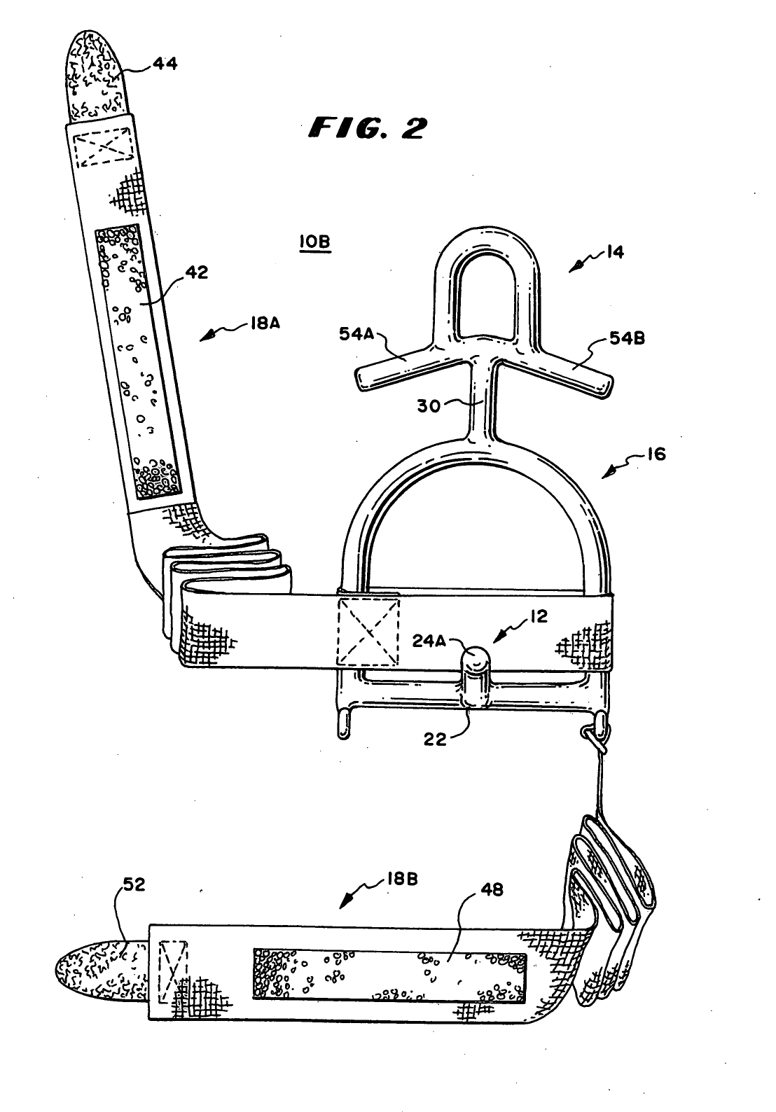

In FIG. 2, there is shown a second embodiment of animal carcass hitch 10B which is similar in every respect to the hitch 10A of FIG. 1 except that instead of the curved and slanted right and left side bars 28A and 28B of the embodiment 10A of animal carcass hitch shown in FIG. 1, it includes shorter slanted side bars 54A and 54B. The similar parts are given the same numbers in embodiment 10B shown in FIG. 2 as in the embodiment 10A of FIG. 1.

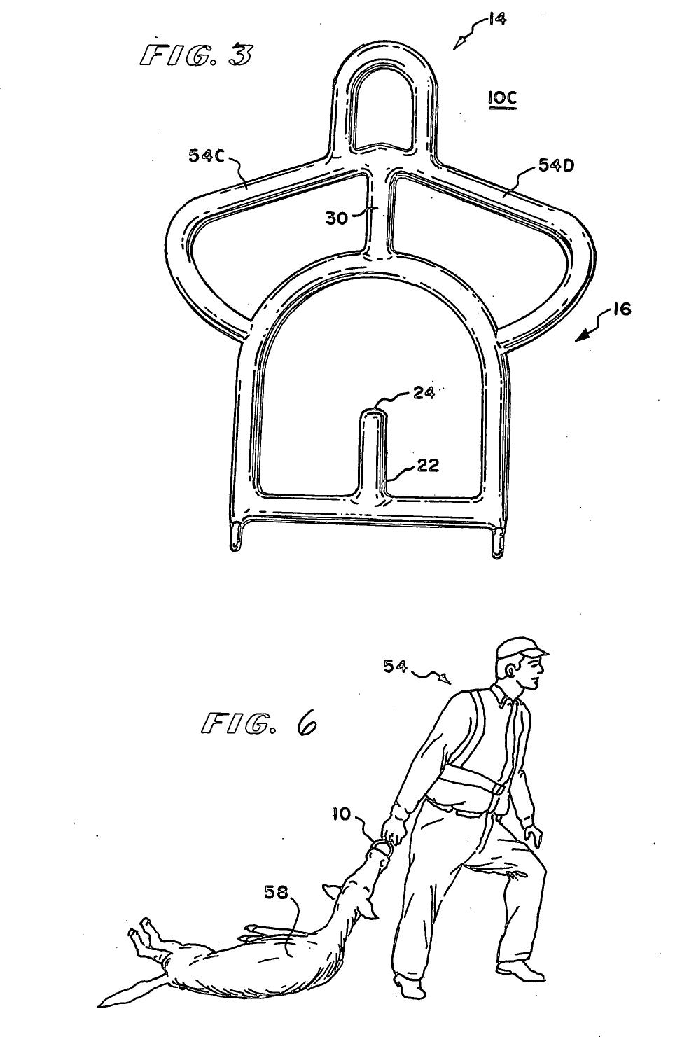

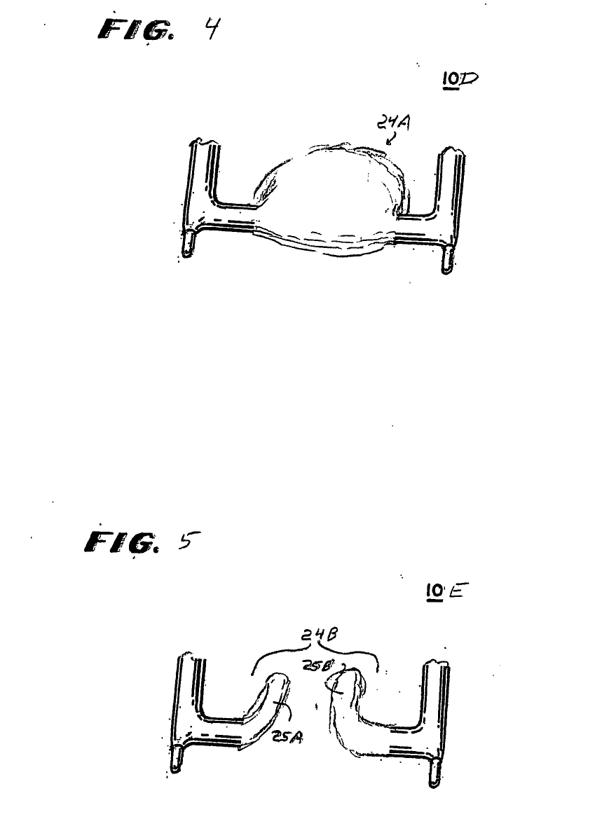

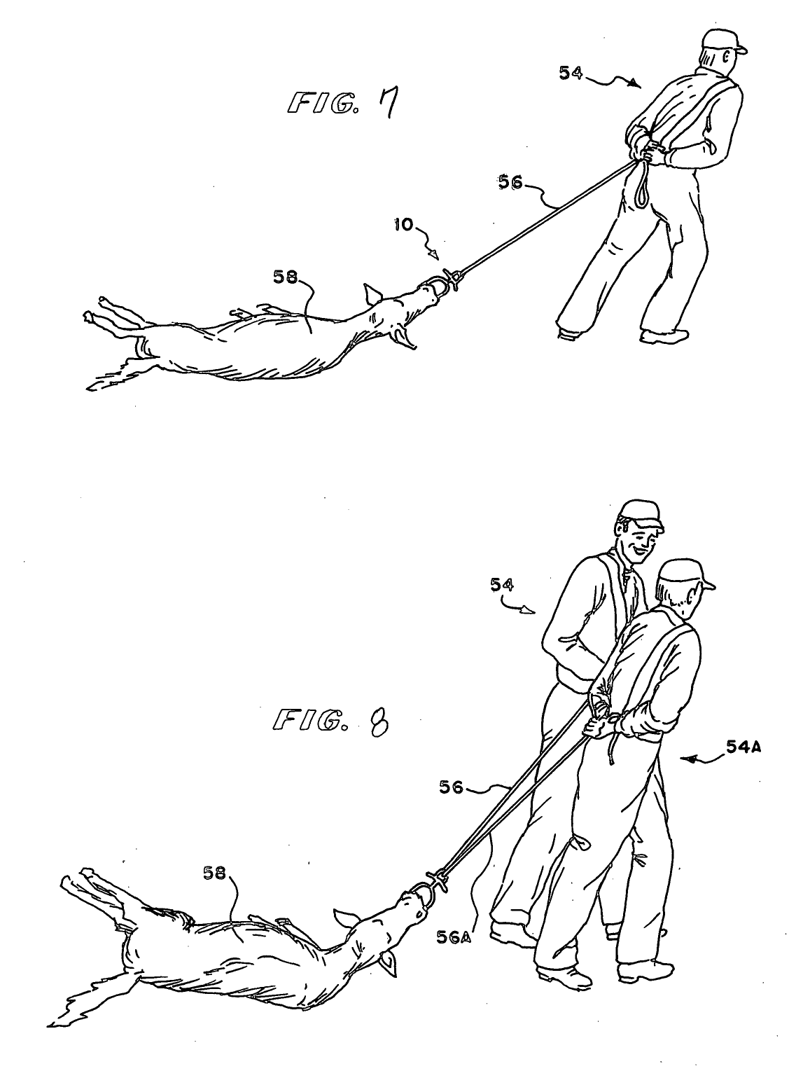

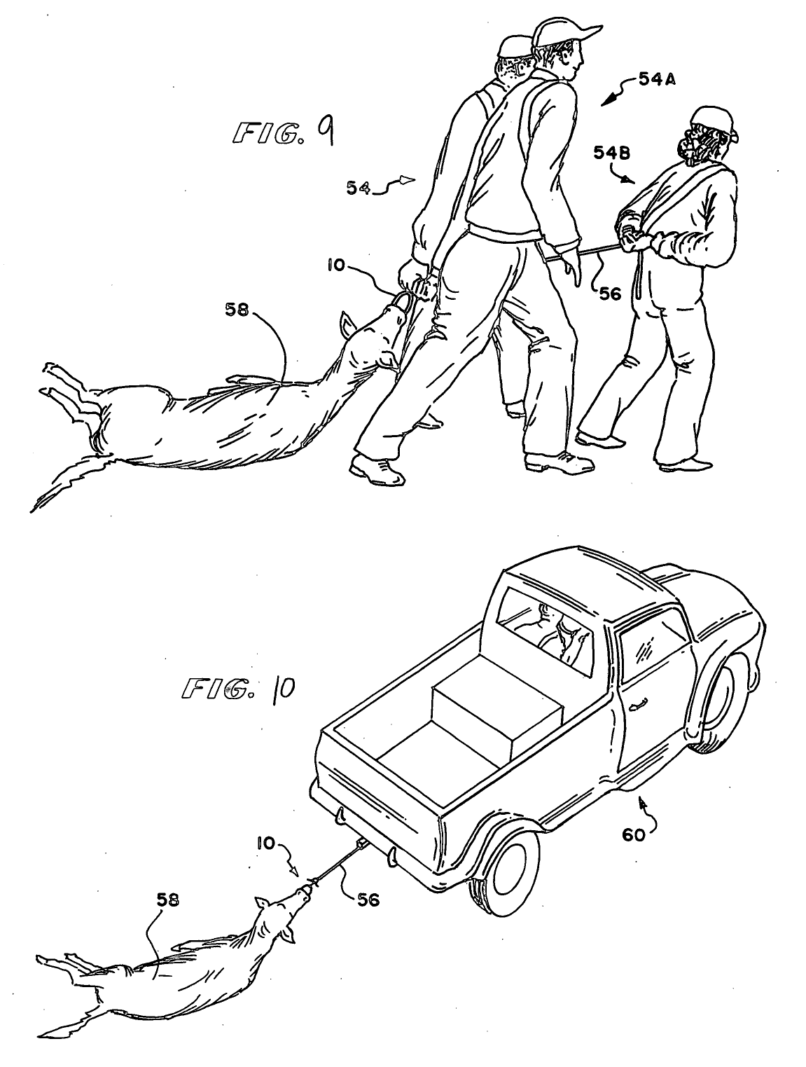

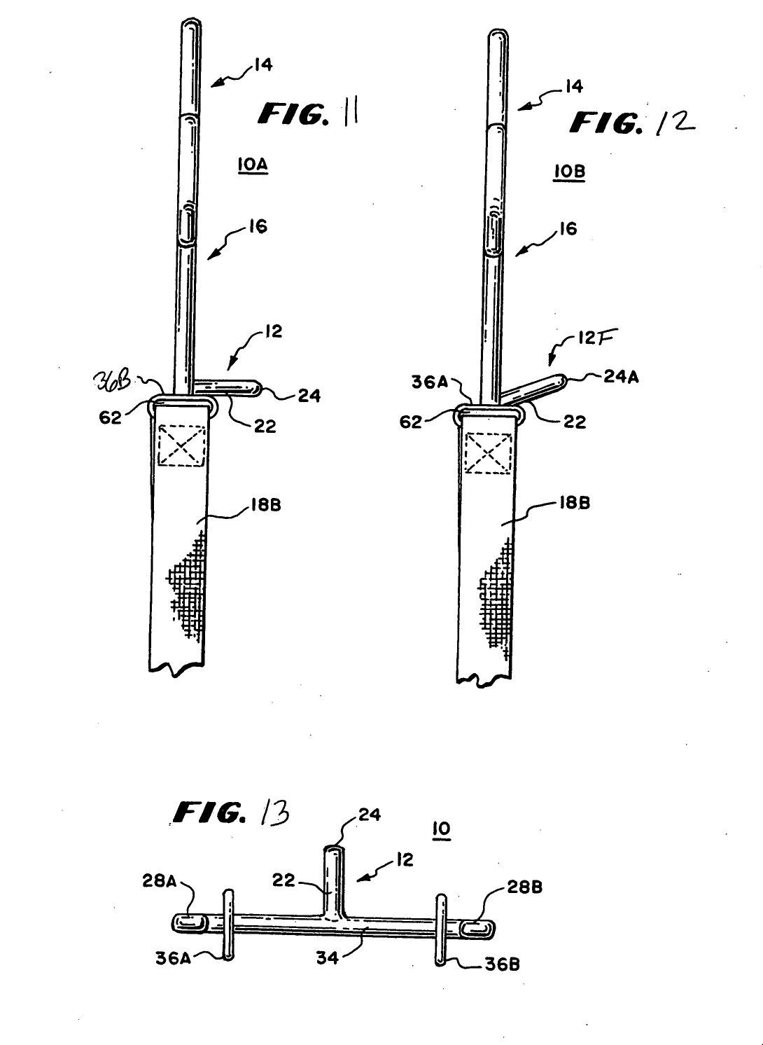

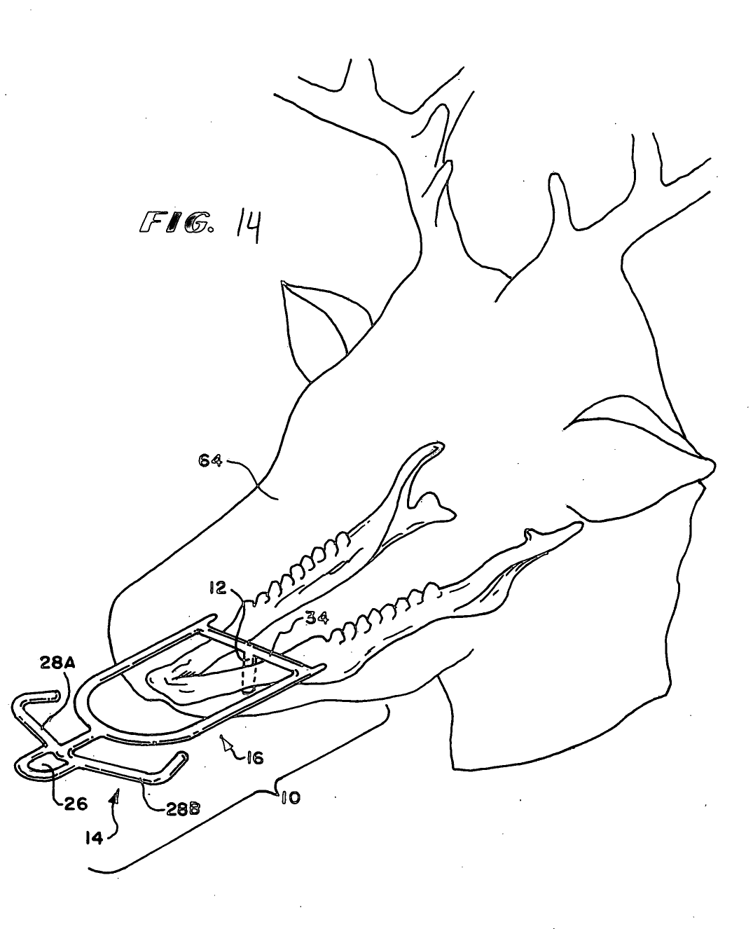

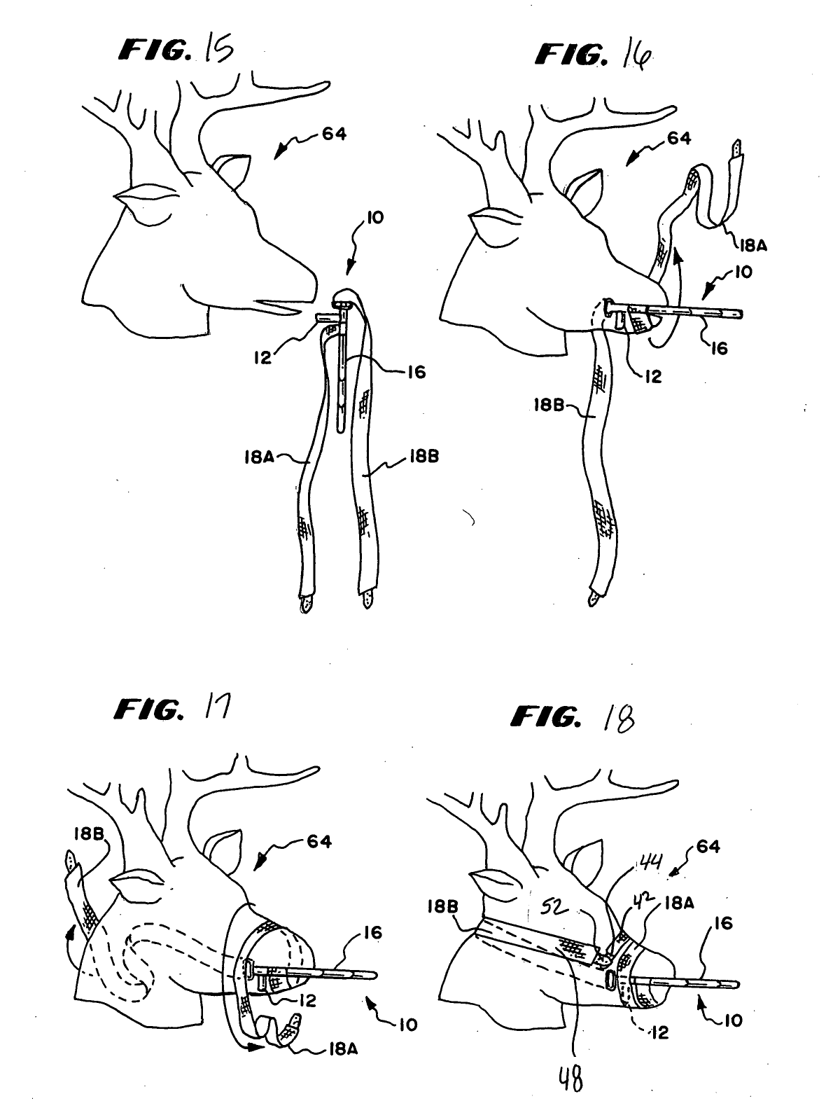

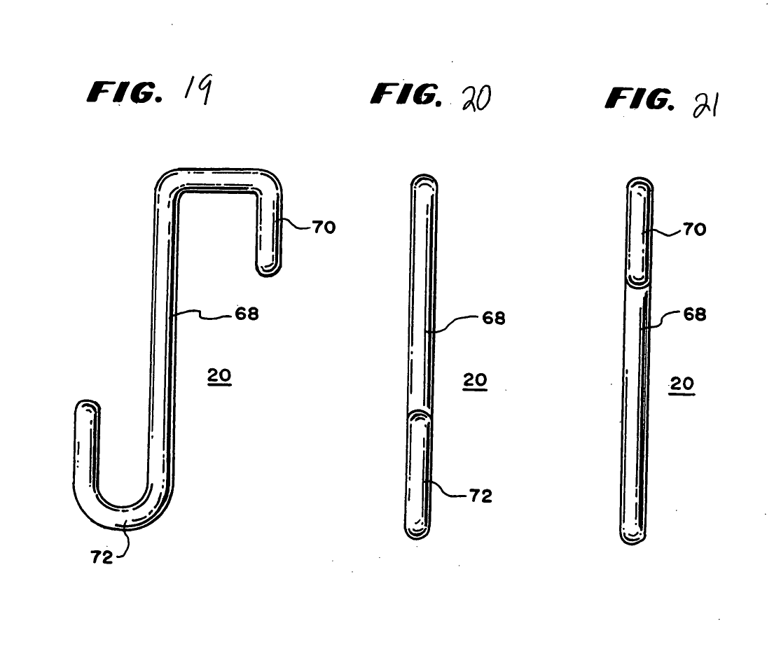

In FIG. 3, there is shown a third embodiment of animal carcass hitch 10C which is similar in every respect to the hitch 10A of FIG. 1 except that instead of the curved and slanted right and left side bars 28A and 28B of the embodiment 10A of animal carcass hitch shown in FIG. 1, it includes side bars 54C and 54D that curve back into intimate contact with the base 16 to form closed loops. The similar parts are given the same numbers in embodiment 10C shown in FIG. 3 as in the embodiment 10A of FIG. 1.

In FIG. 4, there is shown a fragmentary view of a portion of a fourth embodiment of animal carcass hitch 10D which is similar in every respect to the hitch 10A of FIG. 1 except that instead of the skeleton contacting pin 24 of the embodiment 10A of animal carcass hitch shown in FIG. 1, it includes a solid skeleton contacting member 24A that substantially fills the oral cavity within the animal jaws.

In FIG. 5, there is shown a fragmentary view of a portion of a fifth embodiment of animal carcass hitch 10E which is similar in every respect to the hitch 10A of FIG. 1 except that instead of the skeleton contacting pin 24 of the embodiment 10A of animal carcass hitch shown in FIG. 1, it includes a two piece skeleton contacting member 24B that is formed of two spaced apart solid hooks 25A and 25B that open upwardly and have their curved portions facing each other to contact the skeleton within the animal jaws.

In FIG. 6, there is shown a hunter 54 holding the handle of the animal carcass hitch 10 which is mounted within the muzzle of a deer 58 to haul it from a wooded area. In FIG. 7, there is shown a perspective view of a hunter 54 pulling a deer 58 from the forest with a rope 56 that is tied to the eye 26 (FIGS. 1 and 2) of the animal carcass hitch 10. In FIG. 8, there is shown two hunters 54 and 54A each tethered to a safety harness with one end of a rope threaded through the eye 26 of the hitch 10 to pull a deer 58 from the woods. The hunter 54 has one end of one side of the rope 56 and the other hunter 54A has the other side of a rope 56A. In FIG. 9, there is shown three hunters 54, 54A and 54B pulling a deer 58 which has the animal carcass hitch 10 in its mouth with one of the hunters 54 holding one of the side bars 28A, a second hunter 54A holding the other side bar 28B of the hitch 10 and still another hunter 54B tethered to a body harness with a rope 56 attached to the eye 26 (FIGS. 1 and 2) of the animal carcass hitch 10 so that all three hunters may pull on the deer 58 to haul it. In FIG. 10, there is shown a vehicle 60 connected by a rope 56 or by a hanger supporting hook 70 on the other end of the elongated web portion 68 (FIGS. 19-21 to the animal carcass hitch 10 that is fastened at one end within the muzzle of a deer 58 to pull the deer by means of the vehicle 60. It may be attached at any point to the vehicle.

In FIG. 11, there is shown a fragmentary side view of the animal carcass hitch 10A having the stabilizing strap 18B, the muzzle portion strap loop 36B, the skeleton contacting pin 12, the base 16 and the handle 14. As shown in this view, the strap 18B may thread through an opening 62 in the strap loop 36B. The skeleton contacting pin 12 in the embodiment of FIG. 11 extends orthogonally outwardly from the base 16 with a column 22 ending in a rounded end 24. The rounded end 24 is optional and could be flat or pointed but a rounded end is preferred to avoid cutting or the like.

In FIG. 12, there is shown a fragmentary side view of an animal carcass hitch 10F having the corresponding parts of FIG. 11, labeled with the same numbers. The embodiment 10F differs from the embodiment 10A of FIG. 11 in that the skeleton contacting pin 12F extends at an angle with a post 22F forming an angle in the longitudinal axis of the animal carcass hitch. The angle is most acute between the base 16 and the post 22F and obtuse in the direction of the stabilizing strap 18B. It is within the medial plane of the animal carcass hitch. Different angles may be utilized such as sixty degrees to ninety degrees. This angle aids in exerting pressure directly against the skeleton when the animal carcass is being pulled from its nose forwardly which is the normal direction that would be utilized. It thus will have its highest compression strength in the direction of movement.

In FIG. 13, there is shown an end view of the animal carcass hitch 10 having the skeleton contacting pin 12 extending upwardly with its column 22 orthogonal to the pin connection portion 34 of the base 16 and having a rounded end 24. As best shown in this view, the two right and left head strap loops 36A and 36B extend longitudinally from the pin connection portion 34 to provide sufficient width for the stabilizing straps 18A and 18B (FIGS. 1 and 2). The right and left side bars 28A and 28B slant downwardly from the base 16 to avoid slippage towards the ends of the right and left side bars when pulling in the direction of the muzzle of the animal carcass. In the preferred embodiment, the angle is approximately 20 degrees but may be any angle that will result in a pulling force on the handle 14 having a component in the direction of the center of the handle 14 to avoid having the hunter's hands slip from the handle 14 when pulling a carcass.

In FIG. 14, there is shown a fragmentary schematic view of a deer head 64 with an animal carcass hitch 10 mounted in place with the skeleton contacting pin 12 extending downwardly against the jaw of the deer head 64 and with the base 16 mounted partly within the deer head and partly out of the deer head to support the handle 14. With this arrangement, the handle 14 when pulled to drag an animal carcass along the ground, pushes on the skeleton of the deer by the pin 12 to elongate the muscles and pull the deer in stable fashion with the maximum pressure pulling the skeleton in tension.

In FIGS. 15, 16, 17 and 18, there are shown four side views of a deer head 64 in different stages of having an animal carcass hitch 10 fastened into it. These views together form a developed view illustrating the manner in which the stabilizing straps 18A and 18B are positioned after the base 16 and skeleton contacting pin 12 are positioned within the mouth of an animal carcass. These FIGS. show the steps of gripping the lower jaw of the animal carcass within the adjustable fixture with the skeleton contacting pin 12 pressing against the lower jaw, the step of fastening the upper and lower jaw together and the step of gripping the head of the animal. For some animals with fully developed jaws, the flexible straps 18A and 18B may be unnecessary and the adjustable fixture and skeleton contacting pin 12 may be adequate to pull the animal to the desired location. However, for some immature animals, there is insufficient support in the lower jaw for the animal hitch 10 to operate in the best mode without the aid of the flexible straps 18A and 18B.

As shown in FIG. 15, the animal hitch 10 is first positioned substantially perpendicular to the muzzle of the animal in a location that will enable the animal's lower jaw to fit within the adjustable fixture between the loop 38 (FIG. 1) and the pin connection portion 34 (FIGS. 1 and 13) with the handle 14 (FIGS. 1-3, 11, 12 and 14) extending downwardly from the muzzle. As shown in FIG. 16, when the handle 14 is moved in a direction to pull it in line with the muzzle of the animal, the skeleton contacting pin 12 presses into the lower jaw. One side of the adjustable member 18B, which is the movable loop 38 (FIG. 1), and the pin connection portion 34 which supports the skeleton contacting pin 12 grips the lower jaw with the handle 14 extending outwardly to pull the jaws together when the handle is pulled.

As shown in FIGS. 16 and 17, the stabilizing strap 18A is pulled under the lower jaw from the moveable loop 38 (FIG. 1) and threaded between the rigid parallel sides of the base 16 and the jaw so that it passes from one end of the moveable loop 38, under the jaw of the animal and upwardly above the other parallel rigid side of the base 16 to hold the jaw closed. It is then wound over the upper jaw as shown in FIG. 16 and wound as many times as possible outside the rigid parallel side members before being fastened together by the hook and loop fastener. As best shown in FIGS. 17 and 18, the stabilizing strap 18B, which has one end fastened near the eyelet 36B (FIG. 1) is pulled around the back of the head of the animal and pulled forwardly through the opposite eyelet 36A (FIG. 1) and then through the eyelet 36B to grip the head of the animal carcass to the hitch 10. It may then be wound around the muzzle and fastened together.

Because the loop portions 42 and 48 of the hook and loop fasteners extend a substantial length along the straps, the straps may be pulled tightly and the hook portions 44 and 52 connected to the loop portions 42 and 48 at the appropriate position to provide a tight binding action to hold the head and muzzle tightly with the skeleton contacting pin 12 pressed securely against the jaw. The base 16 and stabilizing straps 18A and 18B form a fixture that securely holds the skeleton contacting pin 12 in place while the animal carcass is being pulled. The base 16 includes rigid side members that space the skeleton pin from the sides of the jaw and hold it from lateral movement while the stabilizing straps 18A and 18B hold the jaw closed and resist movement of the pin toward the front of the jaw.

In FIGS. 19, 20 and 21, there are shown a side elevational view, a front elevational view and a rear elevational view of the hanger 20 having a web portion 68 with a hanger eye connection hook 72 on one end of the web portion 68 and a hanger supporting hook 70 on the other end of the elongated web portion 68. With this arrangement, the hanger eye connection hook 72 may be passed through the eye 26 (FIG. 1) of the animal carcass hitch 10 and the animal carcass lifted up with the hanger supporting hook 70 being mounted to a supporting rope or the like to hang up the carcass from a roof rafter.

In operation, after an animal such as a deer has been killed, the hunter unpacks the animal carcass hitch 10 and inserts it into the muzzle of the animal with the skeleton contacting pin 12 pressed against the lower jaw of the animal, and then stabilizing straps 18A and 18B are positioned. The animal is then removed from its location by dragging it nose first.

To obtain an animal carcass which must be pulled from an inaccessible location such as a forest or a swamp or the like, the hunter packs an animal carcass hitch 10 in a small compact container preferably of cloth with the stabilizing straps 18A and 18B wrapped around the hitch. Because the hitch 10 and the hanger 20 are coated with a noise deadening material, the hunter may carry them with him while hunting for an animal such as a deer without making clanking noises of metal parts hitting against each other. The hitch 10 is a single piece and does not clank together and the straps 18A and 18B do not have metal parts.

Upon killing an animal such as a deer, the hunter or other person may insert the skeleton contacting pin 12 and as much of the base 16 into the muzzle of the animal as necessary for the skeleton contacting pin 12 to press against the lower jaw of the animal as shown in FIG. 16. In the alternative, a portion of the hitch 10 may be inserted into the muzzle of the animal with the skeleton contacting pin 12 pressing against the lower jaw. The skeleton contacting pin 12 must make a firm connection with the skeleton contact point of the animal carcass to pull through the skeleton with the connecting tissue being in tension as the animal is dragged nose first.

With the skeleton contacting pin 12 and a portion of the base 16 in place within the muzzle of the animal and the handle portion 14 extending from the muzzle, in the position shown in FIG. 14, the stabilizing straps 18A and 18B are used to secure the animal carcass hitch in place within the muzzle of the animal. To do this, the muzzle stabilizing strap 18A is pulled outside of the jaw and wrapped securely around the jaw to hold the jaw of the animal closed, then wrapped outside the muzzle portion 32. It is securely attached in place with the hook portion 44 of strap 18A in contact with the loop portion 48 of the strap 18A of the hook and loop fastener securely in place and the stabilizing strap 18A tight. The head stabilizing strap 18B is then wrapped around the back of the head or around the neck at the base of the head or antlers of male deer for example, to hold the base and skeleton contacting pin 12 from slipping outwardly of the muzzle and fastened in place utilizing the hook 52 and loop 48 portion of the head strap 18B. With this arrangement, a stabilizing strap 18B pulls the animal carcass hitch 10 securely against the back of the head of the animal and the muzzle strap 18A holds the jaw together while the animal is pulled with its skeletal bones and connecting ligament in tension to a more accessible location.

To pull the animal carcass, a single person may grasp the right and left side bars 28A and 28B (FIG. 6) or one of them with one hand or two hands and pull. In the alternative, one hunter may pull on one of the side bars such as 28A and another hunter pull on the other side bar 28B. Instead of one hunter pulling on one side bar and the other hunter pulling on the other side bar, a rope 56 (FIGS. 7 and 8) or other elongated member may be passed through the eye 26 of the handle 14 (FIG. 1) and one hunter may grab one end of the elongated member and the other hunter grab the other end and both may pull to drag the animal out. Instead, two elongated members may be used and each of them having one end tied to the eye 26 or to the side bars 28A and 28B to be pulled by an individual hunter. If three hunters or other persons are to pull the carcass out (FIG. 9), one may pull on one side bar 28A, the other on another side bar 28B and a third may pull on a rope 56 or the like connected to the eye 26 of the handle 14. In this manner, the deer may be held in a stable position with balanced forces while several persons pull on it. Indeed, a rope through the eye may be pulled by a number of different hunters if desirable.

Because the animal is in a stable position while it is being pulled with tension going through the skeleton and connecting tissue, it may be easily maneuvered around and over obstacles. Its head can be kept upwardly to not snag obstacles. Its legs drag and are positioned by the dragging to be less likely to be snagged on obstacles. When the animal is to be hung, the hanger may have a hook portion inserted through the eye and lifted up by the other portion of the hanger and the animal hung head first in that manner.

From the above description, it can be understood that the animal carcass hitch of this invention has several advantages, such as for example: (1) the animal may be hauled along the ground in a stable position with the force being applied from the jaw through the skeleton and connecting tissues so that it is easily maneuverable with the head lifted and the limbs dangly behind, all of which are in tension through connecting tissue in the skeleton; (2) the animal carcass hitch is coated with a non-slip material to be easily kept clean; (3) the animal carcass hitch is free of sharp pointed edges that might penetrate the skin of a person hauling the animal carcass; (4) the animal carcass hitch of this invention is coated with a sound absorbing material and the hard portions of it are formed as a single unit to avoid clanking noises that might otherwise frighten animals; (5) the animal carcass hitch of this invention is small and compact and maybe easily packed and carried by a hunter; (6) the animal hitch of this invention is mounted so that a skeleton pressure point is connected in tension by a pin and held securely in place by easily connectable straps through hook and loop fasteners; (7) the animal carcass hitch of this invention provides for symmetrical hauling by one person or by several people; and (8) the animal carcass hitch of this invention is easily adaptable to hang the animal carcass up by its snout.

What is claimed is:

1. An apparatus for dragging an animal carcass, comprising:
an elongated member;
a skeleton contacting pin;
a handle;
said handle being mounted to one end of said elongated member;
said skeleton contacting pin being mounted to the other end of said elongated member; and
said skeleton contacting pin being positioned to contact a skeleton contact point of said animal carcass when said apparatus is being used to drag an animal carcass.

2. An apparatus in accordance with claim 1 wherein the handle is a multiple symmetrical gripping point handle.

3. An apparatus in accordance with claim 1 in which said skeleton contacting pin is a single elongated member.

4. An apparatus in accordance with claim 3 in which said elongated pin is orthogonal to the elongated member.

5. An apparatus in accordance with claim 3 in which the elongated pin forms an acute angle with a portion of the elongated member between the elongated pin and the handle.

6. An apparatus in accordance with claim 2 wherein said multiple symmetrical gripping point handle includes a centrally located eye having internal walls to receive an elongated member for pulling said animal carcass.

7. An apparatus in accordance with claim 2 wherein said multiple symmetrical gripping point handle includes a first side bar on one side of said handle and a second side bar on the other side of said handle positioned to be gripped by a person to pull said animal carcass.

8. An apparatus in accordance with claim 7 wherein said first and second side bars slope in a direction away from a center line of said handle wherein a component of the force applied to drag said animal carcass is towards a center line of said handle.

9. An apparatus in accordance with claim 6 further including a hanger having a first hook on one end shaped to fit through said eye and a second hook on an opposite end adapted to hook onto a support to hang said animal carcass.

10. An apparatus in accordance with claim 1 further including a fixture adapted to hold the skeleton contacting pin in place within a muzzle of said animal carcass.

11. An apparatus in accordance with claim 10 wherein the fixture includes a frame that fits at least partly within the muzzle of the animal carcass with portions against sides of the jaws of the animal carcass.

12. An apparatus in accordance with claim 10 wherein the fixture includes an adjustable section, one portion of which fits under a jaw of the animal carcass and the other of which fits above the jaw of the animal carcass and within the muzzle of the animal carcass.

13. An apparatus in accordance with claim 10 wherein the fixture includes flexible members for holding the jaws of the animal carcass together.

14. An apparatus in accordance with claim 13 wherein at least one flexible member is positioned to hold the muzzle closed.

15. An apparatus in accordance with claim 13 wherein at least one flexible member is positioned to grip the head of the animal carcass.

16. The combination of an animal carcass and an animal carcass hitch, comprising:
an animal carcass;
an elongated member;
a skeleton contacting pin;
a handle;
said handle being mounted to one end of said elongated member;
said skeleton contacting pin being mounted to the other end of said elongated member; and
said skeleton contacting pin being in contact with a skeleton contact point of said animal carcass.

17. The combination in accordance with claim 16 wherein the handle is a multiple symmetrical gripping point handle.

18. The combination in accordance with claim 16 in which said skeleton contacting pin is a single elongated member.

19. The combination in accordance with claim 18 in which said elongated pin is orthogonal to the elongated member.

20. The combination in accordance with claim 18 in which the elongated pin forms an acute angle with a portion of the elongated member between the elongated pin and the handle.

21. The combination in accordance with claim 17 wherein said multiple symmetrical gripping point handle includes a centrally located eye having internal walls to receive an elongated member for pulling said animal carcass.

22. The combination in accordance with claim 17 wherein said multiple symmetrical gripping point handle includes a first side bar on one side of said handle and a second side bar on the other side of said handle position to be gripped by a person to pull said animal carcass.

23. The combination in accordance with claim 22 wherein said first and second side bars slope in a direction away from a center line of said handle wherein a component of the force applied to drag said animal carcass is toward the center line of said handle.

24. The combination in accordance with claim 21 further including a hanger having a first hook on one end shaped to fit through said eye and a second hook on an opposite end adapted to hook onto a support to hang said animal carcass.

25. A method of hauling an animal carcass, comprising the steps of:
inserting a skeleton contacting pin at a skeleton contact point of an animal carcass; and
pulling the skeleton contacting pin wherein the animal carcass is pulled with a skeleton and connecting tissue of the animal carcass being in tension.

26. The method of claim 25 wherein the step of inserting said skeleton contacting pin includes the step of inserting a frame having side portions spacing the skeleton contacting pin between them with the side portions against sides of the inside of a muzzle whereby the pin is spaced in a central location in the muzzle.

27. The method of claim 25 wherein the step of inserting said skeleton contacting pin includes the step of inserting a frame member supporting the skeleton contacting pin and a handle, whereby the skeleton contacting pin may be pulled by the handle.

28. The method of claim 27 wherein the handle includes a fastener wherein the animal carcass can be hung by a hook connecting the fastener to a raised support.

29. The method of claim 28 wherein the fastener is an eye whereby the hook may engage the eye to hold a hanger and animal carcass in a raised position.

30. The method of claim 25 wherein the step of pulling the skeleton contact pin wherein the animal carcass is pulled includes the step of pulling a multiple symmetrical gripping point handle.

31. The method of claim 30 wherein the step of pulling the skeleton contact pin wherein the animal carcass is pulled comprises the step of having multiple persons pull the carcass with the same multiple symmetrical gripping point handle.

32. The method of claim 26 wherein the step of inserting a frame includes the step of gripping a lower jaw of the animal carcass in an adjustable fixture that is part of the frame with the skeleton contacting pin pressing against the lower jaw.

33. The method of claim 26 wherein the step of inserting a frame includes the step of using at least one flexible member connected at one end to a rigid member of the frame to hold the jaw of the animal carcass closed.

34. The method of claim 26 wherein the step of inserting a frame includes the step of using at least one flexible member to hold the head of the animal carcass to the frame.
